(19) United States
(12) Patent Application Publication
(10) Pub. No.: US 2026/0371240 A1
(43) Pub. Date: Nov. 19, 2026

(54) METHOD AND APPARATUS FOR SUPPORTING SON OR MDT OPERATION IN WIRELESS COMMUNICATION SYSTEM

(71) Applicant: Samsung Electronics Co., Ltd., Suwon-si, Gyeonggi-do (KR)

(72) Inventor: Sangbum KIM, Suwon-si (KR)

(21) Appl. No.: 19/158,765

(22) PCT Filed: Feb. 20, 2024
(86) PCT No.: PCT/KR2024/095429

§ 371 Date: Aug. 21, 2025

(30) Foreign Application Priority Data
Feb. 21, 2023 (KR) 10-2023-0022964
Dec. 20, 2023 (KR) 10-2023-0187713

(51) Int. Cl. H04W 52/02; H04W 24/08; H04W 76/28

(52) U.S. Cl. CPC H04W 52/0203; H04W 24/08; H04W 76/28

(57) ABSTRACT

The present disclosure relates to a 5G or 6G communication system for supporting a higher data transmission rate. Specifically, the present disclosure provides a method and an apparatus for supporting self-organizing networks (SON) or minimization of drive testing (MDT) operations. A method performed by a terminal in a wireless communication system according to embodiments of the present disclosure comprises the steps of: transmitting, to a base station, capability information comprising an indicator indicating a network saving energy (NES) function of the terminal; receiving, from the base station, first setting information comprising an indicator indicating collection and storage of NES information for performing logged minimization of drive testing (MDT); and performing the logged MDT in an idle state or an inactive state on the basis of the first setting information.

### TECHNICAL FIELD

The disclosure relates to a wireless communication system (or a mobile communication system). Specifically, the disclosure relates to a method and apparatus for supporting a self-organising networks (SON) or minimization of drive testing (MDT) operation.

### BACKGROUND ART

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure is to improve a procedure for supporting a self-organising networks (SON) or minimization of drive testing (MDT) operation.

### Solution to Problem

A method performed by a terminal of a wireless communication system according to embodiments of the disclosure includes an operation of transmitting, to a base station, capability information including an indicator indicating that the terminal supports a network saving energy (NES) function, an operation of receiving, from the base station, first configuration information including an indicator indicating collection and storage of NES information for performing logged minimization of drive test (MDT), and an operation of performing, based on the first configuration information, the logged MDT in an idle state or inactive state. The indicator indicating that the NES function is supported may include an indicator indicating that cell DTX is supported.

A method performed by a base station of a wireless communication system according to embodiment of the disclosure includes an operation of receiving, from a terminal, capability information including an indicator indicating that the terminal supports a network saving energy (NES) function, an operation of transmitting, to the terminal, first configuration information including an indicator indicating collection and storage of NES information for performing logged minimization of drive test (MDT), and an operation of receiving, from the terminal, a report associated with the logged MDT. The indicator indicating that the NES function is supported may include an indicator indicating that cell DTX is supported.

### Advantageous Effects of Invention

According to various embodiments of the disclosure, a procedure for supporting a self-organizing networks (SON) or minimization of drive testing (MDT) operation may be efficiently performed.

### BRIEF DESCRIPTION OF DRAWINGS

FIG. 1A illustrates a structure of a next-generation mobile communication system according to an embodiment of the disclosure.

FIG. 1B is a diagram illustrating radio access state transition in a next generation mobile communication system according to an embodiment of the disclosure.

FIG. 1C is a diagram illustrating cell discontinuous transmit (DTX)/discontinuous reception (DRX) for reducing base station's power consumption according to an embodiment of the disclosure.

FIG. 1D is a diagram illustrating a concept of a system information block (SIB)-less cell according to an embodiment of the disclosure.

FIG. 1E is a diagram illustrating technology that collects and reports cell measurement information according to an embodiment of the disclosure.

FIG. 1F is a diagram illustrating a method that collects and reports cell measurement information according to an embodiment of the disclosure.

FIG. 1G is a flowchart of an operation that collects and reports cell measurement information according to an embodiment of the disclosure.

FIG. 1H is a flowchart of an operation that collects cell DTX-related information according to an embodiment of the disclosure.

FIG. 1I is a flowchart of an operation that collects SIB-less cell related information according to an embodiment of the disclosure.

FIG. 1J is a flowchart of an operation that collects information associated with failure of connection with an SIB-less cell according to an embodiment of the disclosure.

FIG. 1K is a flowchart of a user equipment (UE) operation that collects and reports network energy saving (NES) related information according to an embodiment of the disclosure.

FIG. 1L is a flowchart of a base station operation that collects and reports NES related information according to an embodiment of the disclosure.

FIG. 1M is a block diagram illustrating an internal structure of a UE according to an embodiment of the disclosure.

FIG. 1N is a block diagram illustrating a structure of a base station according to an embodiment of the disclosure.

### MODE FOR THE INVENTION

Hereinafter, exemplary embodiments of the disclosure will be described in detail with reference to the accompanying drawings. It should be noted that, in the accompanying drawings, the same or like elements are designated by the same or like reference signs as much as possible. In addition, a detailed description of known functions or configurations that may make the subject matter of the disclosure unclear will be omitted.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, terms and names defined in the 3rd generation partnership project long term evolution (3GPP LTE) or new radio (NR) standards are used for the sake of descriptive convenience. However, the disclosure is not limited by these terms and names, and may be applied in the same way to systems that conform other standards.

In the following description, a base station (BS) is an entity that allocates resources to terminals, and may be at least one of a radio access network (RAN) node, a next generation node B (gNode B, gNB), an evolved node B (eNode B, eNB), a Node B, a wireless access unit, a base station controller, and a node on a network. In the disclosure, the term “eNB” may be interchangeably used with the term “gNB” for the sake of descriptive convenience. That is, a base station described as “eNB” may refer to “gNB”.

A terminal may include a user equipment (UE), a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (5th generation mobile communication standard). In addition, the disclosure may be applied to intelligent services (e.g., smart homes, smart buildings, smart cities, smart cars or connected cars, healthcare, digital education, retail business, security and safety-related services, etc.) on the basis of 5G communication technology and Internet of things (IoT)-related technology. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a terminal (or user equipment (UE)) transmits data or control signals to a base station (BS) (or eNB or gNB), and the downlink refers to a radio link via which the base station transmits data or control signals to the terminal. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment, e MBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eMBB are merely examples of different types of services, and service types to which the disclosure is applied are not limited to the above examples.

Furthermore, in the following description, LTE, LTE-A, LTE Pro, 5G (or NR), or 6G systems will be described by way of example, but the embodiments of the disclosure may also be applied to other communication systems having similar technical backgrounds or channel types. In addition, based on determinations by those skilled in the art, the embodiments of the disclosure may be applied to other communication systems through some modifications without significantly departing from the scope of the disclosure.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

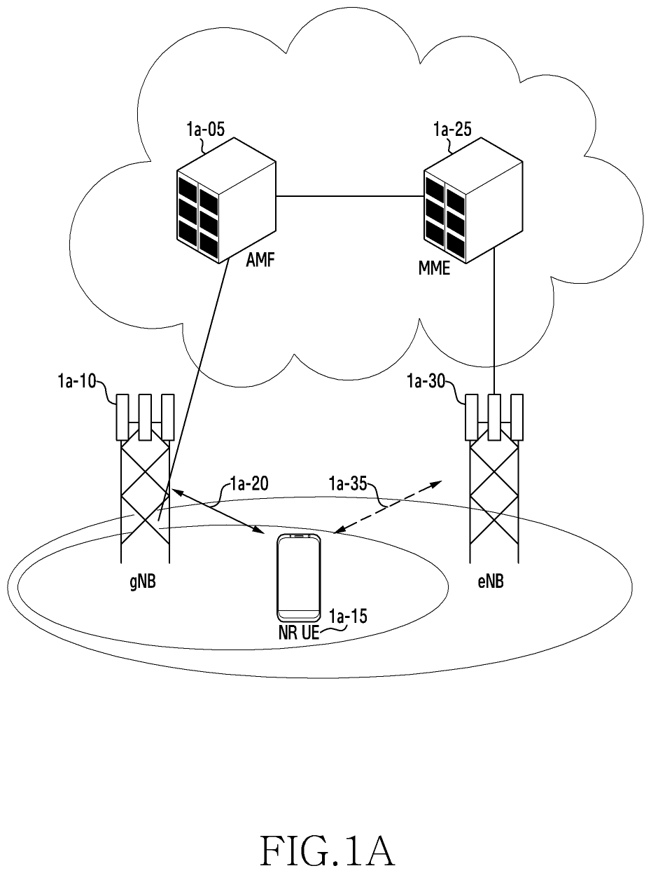

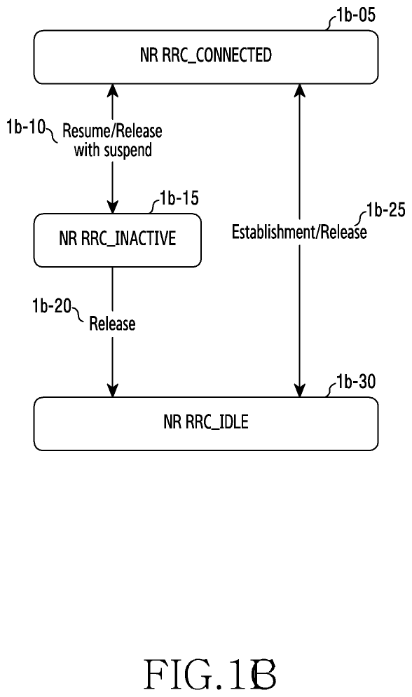

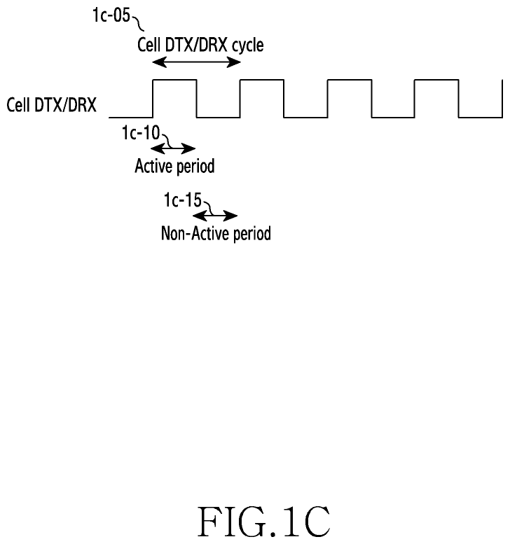

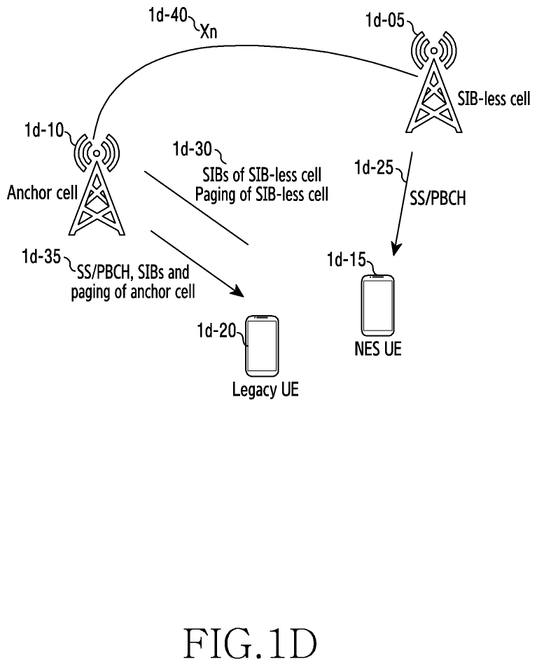

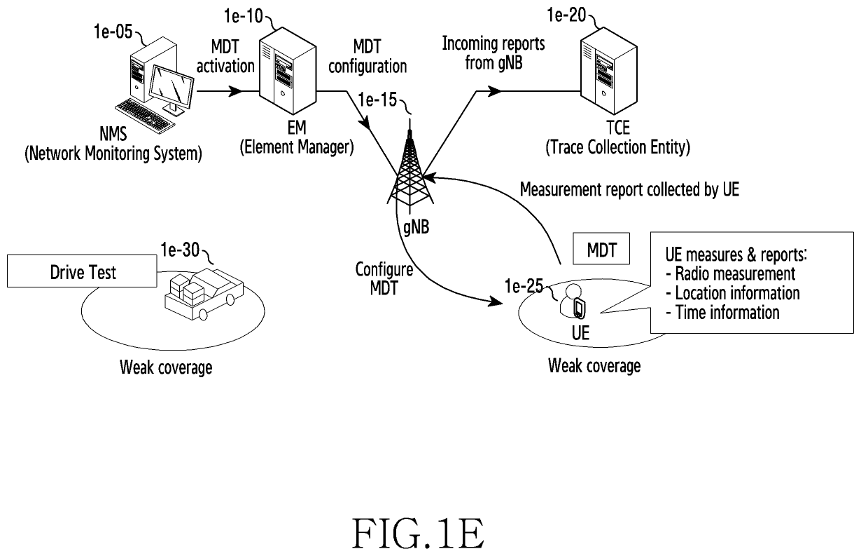

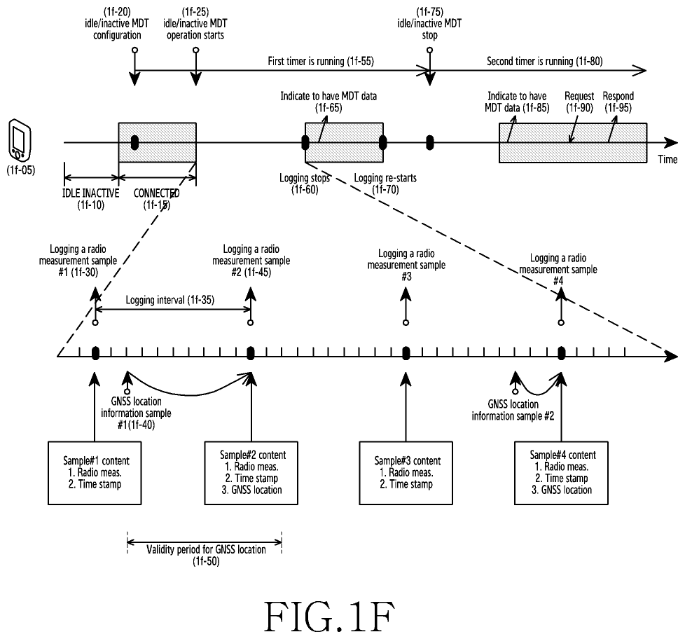

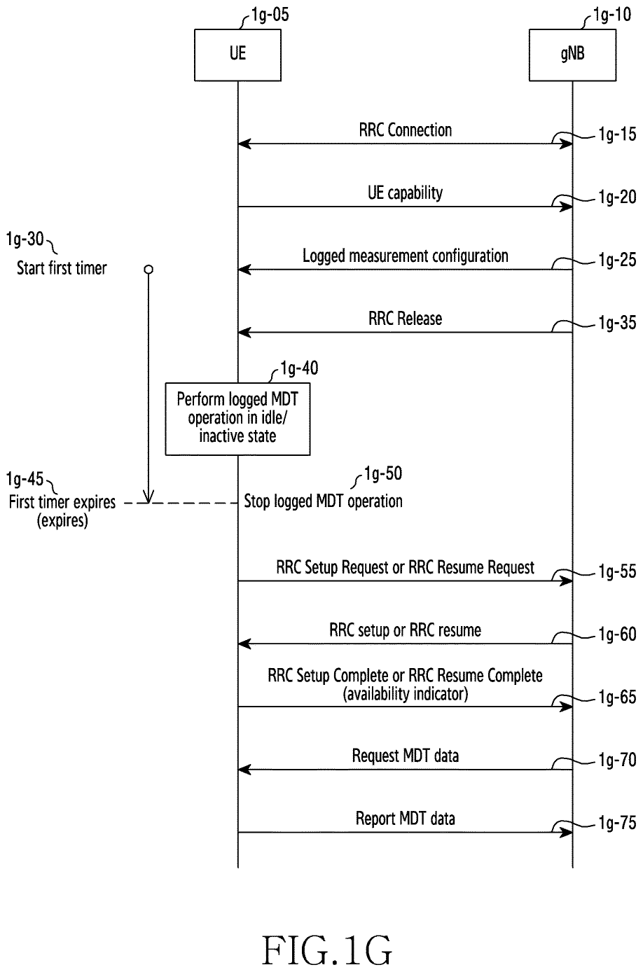

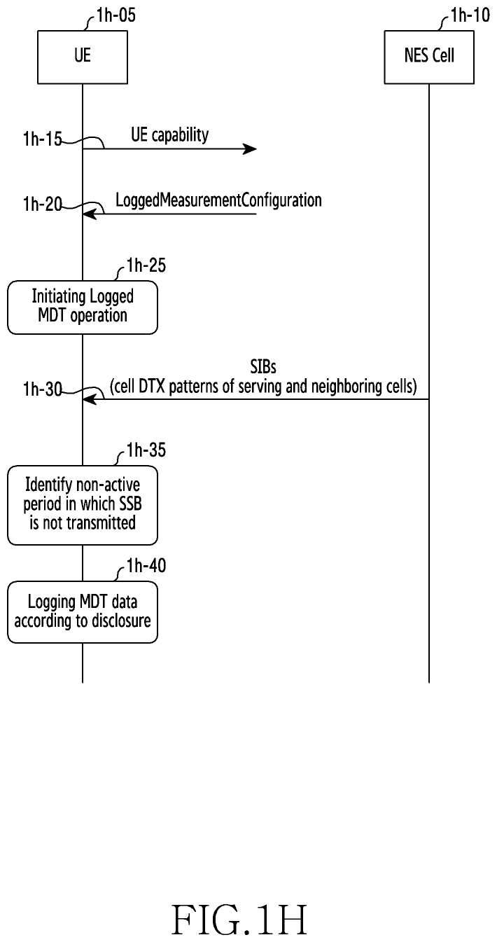

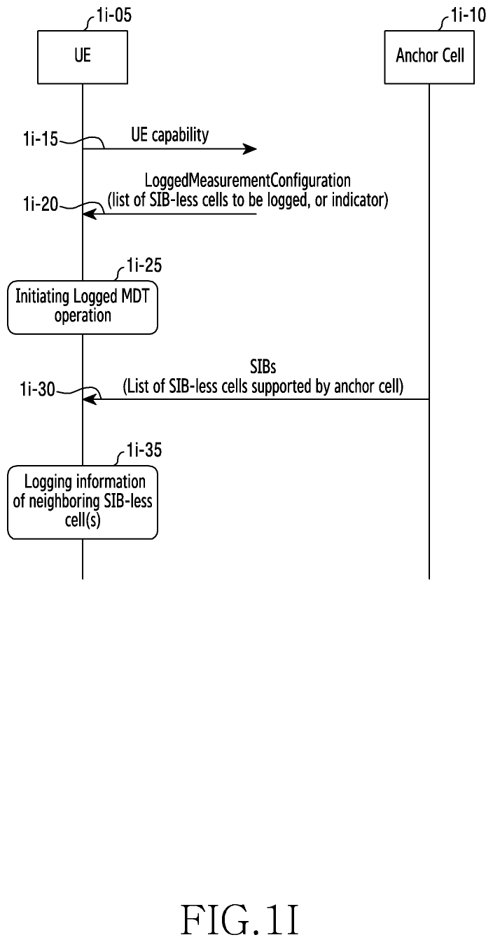

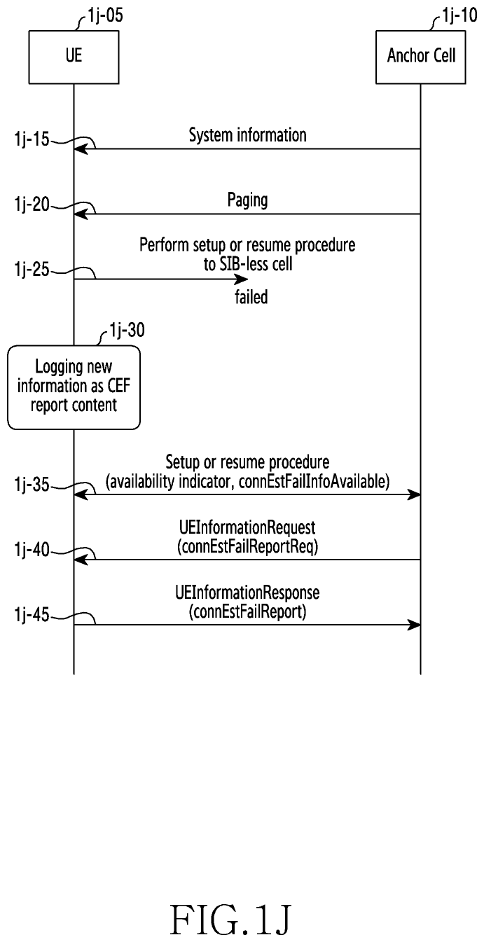

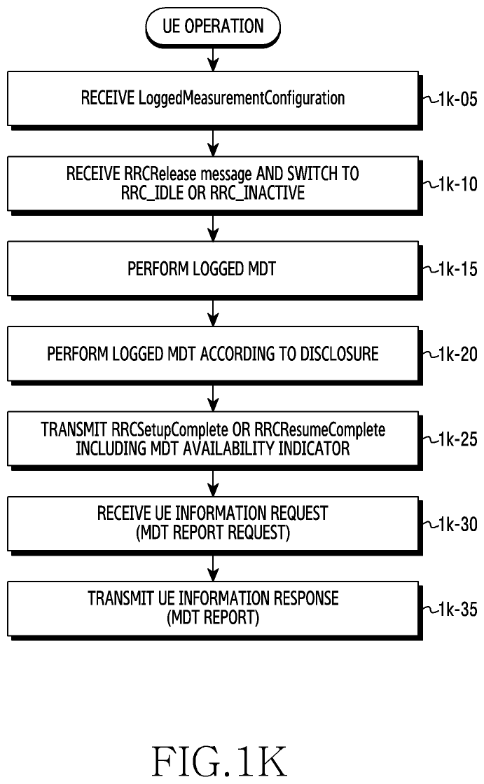

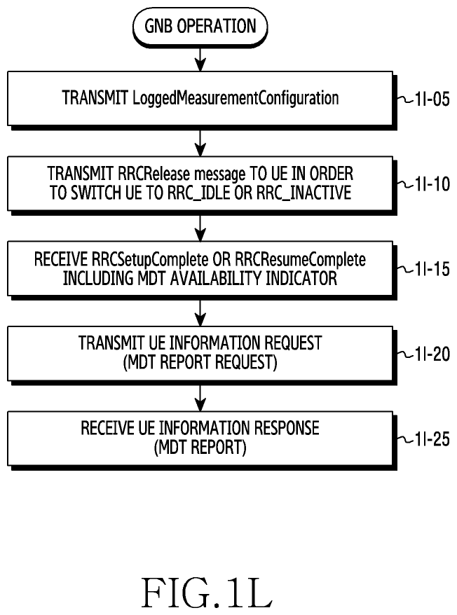

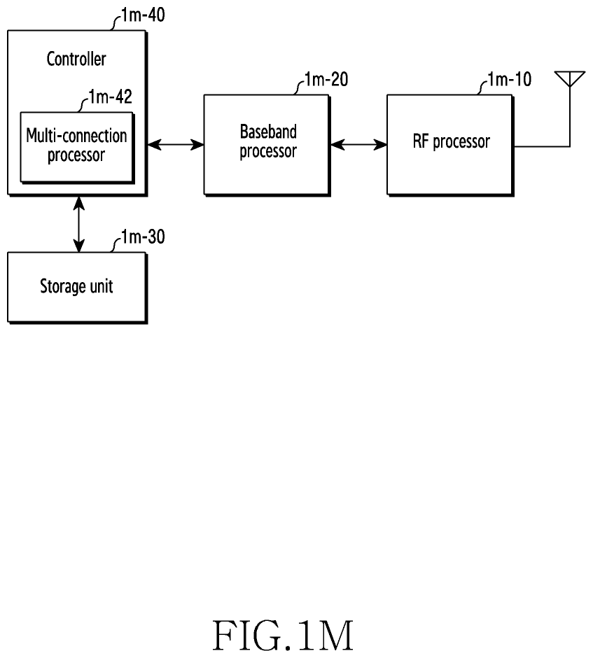

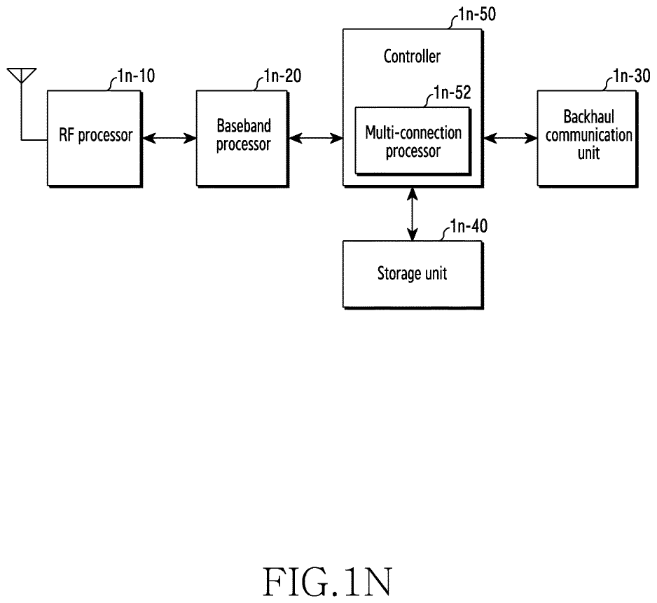

FIG. 1A illustrates a structure of a next-generation mobile communication system.

Referring to FIG. 1A, as illustrated therein, a radio access network of a next-generation mobile communication system (new radio, NR) includes a next-generation base station (new radio node B, hereinafter gNB) 1a-10 and an access and mobility management function (AMF) 1a-05. A user equipment (new radio user equipment, hereinafter NR UE or NR terminal) 1a-15 accesses an external network via the gNB 1a-10 and the AMF 1a-05.

In FIG. 1A, the gNB corresponds to an evolved node B (eNB) of a conventional LTE system. The gNB may be connected to the NR UE through a radio channel and provide outstanding services as compared to a conventional node B (1a-20). In the next-generation mobile communication system, since all user traffic is serviced through a shared channel, a device that collects state information, such as buffer statuses, available transmit power states, and channel states of UEs, and performs scheduling accordingly is required, and the gNB 1a-10 serves as the device. In general, one gNB controls multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to a channel state of a UE. The AMF 1a-05 performs functions such as mobility support, bearer configuration, and QoS configuration. The AMF is a device responsible for various control functions as well as a mobility management function for a UE, and isa connected to multiple base stations. In addition, the next-generation mobile communication system may interwork with the existing LTE system, and the AMF is connected to an MME 1a-25 via a network interface. The MME is connected to an eNB 1a-30 that is an existing base station. A UE supporting LTE-NR dual connectivity may transmit/receive data while maintaining connections to both the gNB and the eNB.

FIG. 1B is a diagram illustrating radio access state transition in a next generation mobile communication system.

In the next generation mobile communication system, there are three types of radio access states (RRC states). A connected mode (RRC_CONNECTED) 1b-05 is a radio access state in which a user equipment (UE) is capable of performing data transmission and reception. An idle mode (RRC_IDLE) 1b-30 is a radio access state in which a UE monitors whether paging is transmitted to the UE. The two modes are radio access states that are also applied to the legacy LTE system, and the details thereof are the same as those of the legacy LTE system. In the next generation mobile communication system, an inactive (RRC_INACTIVE) radio access state 1b-15 is newly defined. In a radio access state, UE context is maintained for a base station and a UE, and RAN-based paging is supported. The features of the new radio access state are as follows.
Cell re-selection mobility;

CN-NR RAN connection (both C/U-planes) has been established for UE;
The UE AS context is stored in at least one gNB and the UE;
Paging is initiated by NR RAN;
RAN-based notification area is managed by NR RAN;

NR RAN knows the RAN-based notification area which the UE belongs to;
The new inactive radio access state may be changed to the connected mode or the idle mode using a predetermined procedure. The inactive mode is changed to the connected mode according to a resume process, and the connected mode is changed to the inactive mode by using a release procedure including suspend configuration information in operation 1b-10. In the procedure, one or more RRC messages are transmitted or received between a UE and a base station, and the procedure includes one or more steps. In addition, the inactive mode is capable of being changed to the idle mode via a release procedure after resumption, in operation 1b-20. Transition between the connected mode and the idle mode is performed according to the legacy LTE technology. That is, the mode transition is performed via an establishment or release procedure in operation 1b-25.

FIG. 1C is a diagram illustrating cell DTX/DRX for reducing base station's power consumption according to an embodiment of the disclosure.

In a mobile communication system, a base station needs to provide services to a plurality of UEs in a service area, and thus consumes a large amount of power. Therefore, there are ongoing discussion regarding various network energy saving (NES) technologies to reduce power consumed by base stations. In the embodiment, a cell that supports at least one of the technologies is referred to as a NES cell, and a UE that supports at least one technology is referred to as a NES UE. For example, in the NR standard, the following candidate technologies are proposed.
Cell DTX/DRX
NES-aware CHO
SSB-less/SIB-less Cell
Cell (Re) Selection enhancement
UE WUS (Wake-up signal)
UE Assistance Information for NES

Among them, cell DTX/DRX is technology that periodically turns on or off data transmission or reception. Cell DTX is technology in which a base station turns on/off data transmission in a downlink, and cell DRX is technology in which a base station turns on/off data reception in an uplink. During a time interval in which a base station turns off data transmission or reception, the base station's power consumption may be significantly decreased.

When cell DTX or cell DRX is operated, a base station performs a predetermined operation corresponding to a period at every cell DRX cycle 1c-05 or based on a predetermined cell DTX configured with an active period 1c-10 and a non-active period 1c-15. During the active period, the base station may perform general operations for providing a service to an existing UE. During the non-active period, data transmission or reception is generally turned off, and specifically, the following options for the base station's operation are considered.
First option: gNB is expected to turn off all transmission and reception for data traffic and reference signal during Cell DTX/DRX non-active periods
Second option: gNB is expected to turn off its transmission/reception only for data traffic during Cell DTX/DRX non-active periods (i.e., gNB will still transmit/receive reference signals)
Third option: gNB is expected to turn off its dynamic data transmission/reception during Cell DTX/DRX non-active periods (i.e., gNB is expected to still perform transmission/reception in periodic resources, including SPS, CG-PUSCH, SR, RACH, and SRS)
Fourth option: gNB is expected to only transmit reference signals (e.g., CSI-RS for measurement)

In the first and fourth options, the base station does not broadcast an SSB which is a common reference signal.

In order to reduce power consumption of a base station, a period for a reference signal (e.g., SSB) may be variably changed or a significantly long period may be applied. The base station may provide SSB period information of a serving cell to a UE via system information or dedicated signaling, and the SSB of the serving cell may be transmitted at intervals of 5, 10, 20, 40, 80, or 160 ms. As the period is long, a base station may reduce the power consumed for SSB transmission, but a UE may have difficulty in quickly recognizing a latest state change of a wireless channel provided by the service cell. To maximize reduction of power consumption of a base station, a new SSB period that is longer than 160 ms may be applied. The new SSB period information may be provided to UEs that support an NES mode via system information or dedicated signaling by a base station that supports an NES.

The disclosure may take into consideration the case in which an SSB is not transmitted in a non-active period of cell DTX or the case in which a UE is incapable of measuring a wireless channel due to a long SSB period, during a predetermined time interval. Although embodiments are described based on the case in which an SSB is not transmitted in a non-active period of cell DTX, the embodiments of the disclose may be applied to a time interval in which an SSB is not measured due to a long SSB period.

FIG. 1D is a diagram illustrating a concept of an SIB-less cell according to an embodiment of the disclosure.

The SIB-less cell 1d-05 is a cell that does not broadcast an SIB for the purpose of reducing power consumption of network equipment. In addition, the cell may also not transmit paging. Instead, an anchor cell 1d-10 located around the SIB-less cell transmits an SIB of the SIB-less cell and paging 1d-30. The SIB-less cell and the anchor cell are connected via a predetermined interface (e.g., Xn), and perform communication and exchange predetermined information required in operation 1d-40. In the embodiment, it is assumed that the SIB-less cell still broadcasts an SSB and an MIB (i.e., SS/PBCH 1d-25). A network energy saving (NES) UE 1d-15 that supports the SIB-less cell may determine whether a cell is the SIB-less cell based on predetermined information included in the MIB broadcasted by the SIB-less cell, and may obtain the SIB of the SIB-less cell and paging from an adjacent anchor cell. A legacy UE 1d-20 may not distinguish the SIB-less cell and a legacy cell. In this instance, since the SIB-less cell does not broadcast the SIB, the legacy UE may regard that the cell is barred. Alternatively, based on existing information included in the MIB of the SIB-less cell, the SIB-less cell may perform barring so that the legacy UE does not perform cell (re) selection with respect to the cell.

FIG. 1E is a diagram illustrating technology that collects and reports cell measurement information in the disclosure.

To establish or optimize a network, a mobile communication operator measures a signal strength in a generally estimated service area, and based thereon, disposes or readjusts base stations in the service area. The operator carries signal measurement equipment in a vehicle, and collects cell measurement information in the service area, which requires a long time and high costs. The process is performed generally utilizing a vehicle, and thus is referred to as a drive test. In order to support operations, such as cell reselection or handover for inter-cell movement, serving cell addition, or the like, a UE includes a function of measuring a signal from a base station. Therefore, instead of the drive test, a UE within a service area may be used, and this is referred to as minimization of drive test (MDT). The operator may configure an MDT operation with respect to predetermined UEs via various devices of a network, and the UEs may collect and store signal strength information from a serving cell and neighboring cells in a connected mode (RRC_Connected), an idle mode (RRC_Idle), or an inactive mode (RRC_Inactive). In addition, various information such as location information, time information, and signal quality information may also be stored. The information stored in this manner may be reported to the network when the UEs are in the connected mode, and the information may be transferred to a predetermined server.

The MDT operation is briefly classified as an immediate MDT and a logged MDT.

The immediate MDT has a feature of immediately reporting collected information to a network. Since immediate reporting needs to be performed, only a UE in the connected mode is capable of performing this. An RRM measurement process for supporting operations such as handover, serving cell addition, or the like is reused, and location information, time information, or the like is additionally reported.

The logged MDT has a feature of storing collected information, instead of immediately reporting the same to a network, and reporting the stored information after a UE is changed to the connected mode. A UE in an idle mode that is incapable of immediately reporting the information performs this. A UE in an inactive mode employed by the next generation mobile communication system performs logged MDT. When a predetermined UE is in the connected mode, a network provides configuration information for performing a logged MDT operation to the UE, and the UE switches to an idle mode or inactive mode, and collects and stores the configured information.

| | RRC state |
|---|---|
| Immediate MDT | RRC_Connected |
| Logged MDT | RRC_Idle, RRC_Inactive |

FIG. 1F is a diagram illustrating a method that collects and reports cell measurement information in the disclosure.

A UE 1f-05 switches from an idle mode or inactive mode 1f-10 to a connected mode 1f-15. In the connected mode, via an immediate MDT operation, MDT data is collected and reported to a base station. The UE switched to the connected mode receives, from the base station, logged MDT configuration information that is performed in the idle mode or inactive mode, in operation 1f-20. The configuration information is included in a predetermined RRC message and transmitted to the UE, and the UE that receives the message operates a first timer in operation 1f-55. Until the first timer expires, the UE operates a logged MDT operation in an idle mode or inactive mode period. The value of the first timer is included in the logged MDT configuration information. When the UE switches to the idle mode or inactive mode, the UE performs logged MDT based on the received configuration information in operation 1f-25. The UE stores predetermined information collected based on a configured cycle that is a logging interval 1f-35, in operations 1f-30 and 1f-45. In addition, when valid location information 1f-40 is collected, the information also needs to be stored. The location information is determined to be valid unless a predetermined time 1f-50 elapses after the information is collected. The predetermined time is shorter than or equal to the logged interval. Even through the first timer does not expire, when the UE is switched to the connected mode, the UE suspends the logged MDT operation that is being performed, in operation 1f-60. However, the first timer continuously operates without suspension even in the connected mode period. That is, the first timer continuously operates irrespective of a change of an RRC state. However, when storage is not performed any longer due to insufficient UE memory that stores MDT data, or when the logged MDT configuration information is cancelled, the first timer is stopped. The case in which the logged MDT configuration information is canceled occurs when another logged MDT configuration information is provided from a serving RAT or another RAT, or when the UE is detached or power is disconnected. During a connection establishment process (RRC connection establishment) or connection resumption process (RRC connection resume), the UE reports, to the base station, that the UE has the stored collected information (MDT data) by using an RRC setup complete message or RRC resume complete message, in operation 1f-65.

The connection establishment process is a process in which a UE switches an idle mode to a connected mode. As shown below, the process generally includes three steps, and uses three types of RRC messages.
Step 1: A UE transmits an RRC setup request message to a base station.
Step 2: The base station transmits an RRC setup message to the UE.
Step 3: The UE transmits an RRC setup complete message to the base station.

The connection resumption process is a process in which a UE switches an inactive mode to a connected mode. As shown below, the process generally includes three steps, and uses three types of RRC messages.
Step 1: A UE transmits an RRC resume request message to a base station.
Step 2: The base station transmits an RRC resume message to the UE.
Step 3: The UE transmits an RRC resume complete message to the base station.

Information indicating that the UE has the collected information is also reported to a target base station during a connection reestablishment process (RRC connection reestablishment) and a handover process, in addition to the connection establishment process or connection resumption process. Although logged MDT is configured, and collected and stored information does not yet exist, reporting is omitted. The base station that receives a report requests reporting of the MDT data that the UE stores. During a predetermined time, the UE needs to continuously store the MDT data that is not reported. When the UE is switched again to the idle mode or inactive mode, and the first timer does not expire yet, the UE resumes the logged MDT operation in operation 1f-70. When the first timer expires, the logged MDT operation is stopped in operation 1f-75. The UE that stops the operation operates a second timer in operation 1f-80, and maintains the stored MDT data until the timer expires. After the timer expires, whether to delete the stored MDT data is determined by implementation by the UE. The value of the second timer is not included or configured in the logged MDT configuration information, but a predetermined value is applied. When the UE is switched again to the connected mode, the UE reports that the UE has the stored collected information (MDT data) to the base station in operation 1f-85. In this instance, by using a predetermined RRC message, the base station requests reporting of the MDT data that the UE stores, in operation 1f-90. Accordingly, the UE includes the stored MDT data in the predetermined RRC message, and reports the message to the base station in operation 1f-95.

FIG. 1G is a flowchart of an operation that collects and reports cell measurement information in the disclosure.

A UE 1g-05 establishes a connection with a base station 1g-10 in operation 1g-15. The UE 1g-05 provides UE capability information to the base station 1g-10 in operation 1g-20, and indicates whether it itself supports an MDT operation and which frequency it is capable of measuring. The base station 1g-10 includes configuration information needed for performing a logged MDT operation in a predetermined RRC message, and transmits the same to the UE 1g-05 in operation 1g-25. For example, the configuration information includes at least one of the following information.
Trace Reference Information
Trace Recording Session Reference Information
TCE (Trace Collection Entity) ID Information: To a data server designated by a TCE ID, a base station transmits MDT data information reported from a UE.
Absolute Time Information (Absolute Time): an absolute time in a current cell that provides logged MDT configuration information.
Area Configuration: area information for collecting and storing measurement information via a logged MDT operation, and indicated in units of cells. In addition, RAT information for which measurement information needs to be collected may be included. A list included in the RAT information is a black list or a white list. In the case of the black list, cell measurement information is collected with respect to an RAT that is not included in the list. In the case of the white list, cell measurement information is not collected with respect to an RAT that is not included in the list.
Logging Duration: When a timer operates with the value of the first timer, a logged MDT operation is performed in an idle mode or inactive mode.
Logging Interval: an interval for storing collected information.
plmn-IdentityList (i.e. MDT PLMN list): PLMN list information, which includes PLMN information capable of reporting whether to store MDT data and reporting MDT data, in addition to performing a logged MDT operation.
An indicator indicating whether a logged MDT operation is performed in the idle mode or the inactive mode, or in both modes. An RRC state for performing a logged MDT operation may be indicated by an indicator, or it may be defined that a logged MDT operation is performed in both the idle mode and the inactive mode at any time, without an indicator. A UE performs a logged MDT operation only in an RRC state indicated by an indicator.
An indicator indicating whether to collect and store beam level measurement information. A beam antenna may be applied in the next generation mobile communication system. Without an indicator, it may be defined that beam level measurement is always collected and stored with respect to a frequency in which a beam-based operation is performed.
Maximum beam number information that is collected or stored, and minimum signal strength information of a beam that is stored. The UE omits storing information of a beam having a strength weaker than a minimum signal strength. When all beams have strengths weaker than the configured minimum signal strength, a UE may store one beam information having the strongest signal strength among them or may include an indicator indicating that all beams have strengths weaker than the minimum signal value.

The UE 1g-05 that receives the logged MDT configuration information operates T330 that is a first timer in operation 1g-30. The value of the first timer is configured to be the same as the value of a logging duration. The base station 1g-10 switches the UE 1g-05 to the idle mode or the inactive mode by using an RRC release message in operation 1g-35. Based on an RRC state which the state is switched to, configuration information for operation in the RRC state is included in the RRC release message. When the first timer is operating, the UE 1g-05 performs logged MDT in the idle mode or inactive mode in operation 1g-40. Signal strength measurement with respect to a serving cell and neighboring cells is performed and location information is obtained. When beam level measurement is configured, a signal strength value for a beam that has a strength higher than a configured minimum value in the serving cell and neighboring cells is collected and stored. A maximum number of beams capable of being stored is configured or previously defined. The signal strength is an RSRP or RSRQ or SINR. The collected information is stored at every logged interval. When the first timer expires in operation 1g-45, the logged MDT operation is stopped in operation 1g-50.

When the UE 1g-05 is in the idle mode or inactive mode based on the RRC release message, and RAN or CN paging is received from the base station 1g-10 or MO data transmission is activated, the UE 1g-05 initializes an establishment process or resume process for switching from the idle mode or inactive mode to a connected mode.

The establishment process or resume process includes the following.
Step 1: The UE transmits an RRC setup request message or RRC resume request message to the base station in operation 1g-55.
Step 2: The base station transmits an RRC setup message or RRC resume message to the UE in operation 1g-60.
Step 3: The UE transmits an RRC setup complete message or RRC resume complete message to the base station in operation 1g-65.

The UE 1g-05 includes an indicator indicating whether the RRC setup complete or RRC resume complete message includes the MDT data that the UE 1g-05 stores. In operation 1g-70, the base station 1g-10 that receives the RRC setup complete message requests reporting of the MDT data by using UEInformationRequest that is a predetermined RRC message, when it is needed. The UE 1g-05 that receives the request reports the MDT data by using UEInformationResponse that is a predetermined RRC message, in operation 1g-75.

FIG. 1H is a flowchart of an operation that collects cell DTX-related information according to an embodiment of the disclosure.

A UE 1h-05 in a connected mode reports its capability information to a predetermined base station in operation 1h-15. The capability information may include an indicator indicating whether the UE 1h-05 supports NES technology, particularly, cell DTX. The UE 1h-05 receives a LoggedMeasurementConfiguration message from the predetermined base station in operation 1h-20. The message includes configuration information needed for performing a logged MDT operation. The configuration information may include an indicator indicating collection and storage of information related to cell DTX. The UE 1h-05 is switched from the connected mode to an idle mode or inactive mode, and performs the logged MDT operation according to the configuration information in operation 1h-25. The UE 1h-05 camps on a single NES cell 1h-10, and obtains cell DTX pattern information applied by the NES cell that the UE camps on and the neighboring NES cells, which is included in predetermined system information broadcasted by the cell, in operation 1h-30. In this instance, the base station that transmits LoggedMeasurementConfiguration in operation 1h-20 and the NES cell 1h-10 may be the same entity or may be different entities from each other. Based on the obtained cell DTX pattern information, the UE 1h-05 recognizes a non-active period, a predetermined time period in which an SSB is not transmitted from the NES cell that the UE camps on and the neighboring NES cells, in operation 1h-35. During the period, an SSB is not transmitted from the NES cell that the UE camps on and the neighboring NES cells, and thus the UE 1h-05 may be incapable of measuring received signal strength and quality of the cells. Therefore, when the SSB is incapable of being measured due to cell DTX, the embodiment proposes a method of storing predetermined information indicating the same in operation 1h-40, and reporting this to the base station.

The UE 1h-05 for which the logged MDT is configured needs to store a predetermined valid measurement result based on a configured interval. The stored information may be identified via LogMeasReport that the UE 1h-05 subsequently reports to the base station. The following ASN.1 code is extracted from the TS38.331 standard document. The following LogMeasReport is included in a UEInformationResponse message and is reported to the base station by the UE 1h-05. Information stored for each interval is included in a single LogMeasInfo IE. In this instance, a measurement result associated with the serving cell that the UE camps on is included in the following measResultServingCell field, and a measurement result associated with the neighboring NR cells is included in the following measResultNeighCellListNR field.

| LogMeasReport-r16 ::= | SEQUENCE { | |
|---|---|---|
| absoluteTimeStamp-r16 | AbsoluteTimeInfo-r16, | |
| traceReference-r16 | TraceReference-r16, | |
| traceRecordingSessionRef-r16 | OCTET STRING (SIZE (2)), | |
| tce-Id-r16 | OCTET STRING (SIZE (1)), | |
| logMeasInfoList-r16 | LogMeasInfoList-r16, | |
| logMeasAvailable-r16 | ENUMERATED {true} | OPTIONAL, |
| logMeasAvailableBT-r16 | ENUMERATED {true} | OPTIONAL, |
| logMeasAvailableWLAN-r16 | ENUMERATED {true} | OPTIONAL, |

...
}

| | |
|---|---|
| LogMeasInfoList-r16 ::= | SEQUENCE (SIZE (1..maxLogMeasReport-r16)) OF |

LogMeasInfo-r16

| LogMeasInfo-r16 ::= | SEQUENCE { | |
|---|---|---|
| locationInfo-r16 | LocationInfo-r16 | OPTIONAL, |
| relativeTimeStamp-r16 | INTEGER (0..7200), | |
| servCellIdentity-r16 | CGI-Info-Logging-r16 | OPTIONAL, |
| measResultServingCell-r16 | MeasResultServingCell-r16 | OPTIONAL, |
| measResultNeighCells-r16 | SEQUENCE { | |
| measResultNeighCellListNR | MeasResultListLogging2NR-r16 | OPTIONAL, |
| measResultNeighCellListEUTRA | MeasResultList2EUTRA-r16 | OPTIONAL |

},

| | | |
|---|---|---|
| anyCellSelectionDetected-r16 | ENUMERATED {true} | OPTIONAL, |

```
  ...,
  [[
```

| | | |
|---|---|---|
| inDeviceCoexDetected-r17 | ENUMERATED {true} | OPTIONAL |

]]
}

When the UE 1h-05 fails to collect a measurement result associated with the serving cell since the serving NES cell does not transmit an SSB during a non-active period of cell DTX, the UE 1h-05 needs to determine information to be included in the measResultServingCell field. The embodiment proposes two options. A first option is to include, in the field, the measurement result associated with the serving cell that the UE 1h-05 most recently included in the measResultServingCell field. This means to include the measurement result associated with the serving cell that was measured last in the latest active period of cell DTX and stored in the measResultServingCell field. A second option is not to include the measResultServingCell field in the LogMeasInfo IE in which the UE 1h-05 fails to collect a measurement result associated with the serving cell. In the options, in the LogMeasInfo IE in which the UE 1h-05 fails to collect a measurement result associated with the serving cell, the UE 1h-05 includes an indicator indicating that the UE 1h-05 fails to collect a measurement result associated with the serving NES cell (or an indicator indicating that the serving NES cell is in a non-active period of cell DTX) since an SSB is not transmitted during the non-active period of cell DTX.

When the UE 1h-05 fails to collect a measurement result associated with the neighboring NES serving cell since the neighboring NES cells do not transmit an SSB during a non-active period of cell DTX, the UE 1h-05 needs to determine information to be included in the measResultNeighCellListNR field. The embodiment proposes two options. A first option is to include, in the field, the measurement result associated with the neighboring NES cell that the UE 1h-05 included most recently in the measResultNeighCellListNR field. This means to include the measurement result associated with the neighboring NES cell that was measured last in the latest active period of cell DTX and stored in the measResultNeighCellListNR field. A second option is not to include the measResultNeighCellListNR field in the LogMeasInfo IE in which the UE 1h-05 fails to collect a measurement result associated with the serving cell. In the options, in the LogMeasInfo IE in which the UE 1h-05 fails to collect a measurement result associated with the neighboring NES cell, the UE 1h-05 includes an indicator indicating that the UE 1h-05 fails to collect a measurement result associated with the neighboring NES cell (or an indicator indicating that the neighboring NES cell is in a non-active period of cell DTX) since an SSB is not transmitted during the non-active period of cell DTX. In addition, list information of NES cells that are in a non-active period of cell DTX may be included in the LogMeasInfo IE.

As another example, the UE 1h-05 may include the obtained cell DTX pattern information of the serving NES cell and neighboring NES cells in LogMeasReport.

The stored information may be reported to the base station by the UE 1h-05 via a UE information process.

FIG. 1I is a flowchart of an operation that collects SIB-less cell related information according to an embodiment of the disclosure.

The described anchor cell may support one or more SIB-less cells. To this end, the anchor cell may transmit, to UEs, system information of SIB-less cells that the anchor cell supports, in place of them. In addition, the anchor cell transmits, to a predetermined UE, paging including information indicating access to an SIB-less cell that the anchor cell supports, so that the UE connects to the predetermined SIB-less cell. As described above, in order to support the SIB-less cell, the anchor cell needs to recognize a service area of the adjacent SIB-less cell(s) that the anchor cell supports. The service area of the SIB-less cell may be recognized based on predetermined MDT information reported by the UE that is performing logged MDT.

A UE 1i-05 reports its capability information to a predetermined base station in operation 1i-15. The capability information may include an indicator indicating whether the UE 1i-05 supports NES technology, particularly, an SIB-less cell. The UE 1i-05 receives a LoggedMeasurementConfiguration message from the predetermined base station in operation 1i-20. The message includes configuration information needed for performing a logged MDT operation. In the configuration information, an indicator or predetermined information indicating collection and storage of information related to the SIB-less cell may be included. For example, the predetermined information is a list of SIB-less cells to be stored, and the list includes cell ID information (e.g., a physical cell ID (PCI), a cell global ID (CGI), frequency information (ARFCN-ValueNR), and an index indicating an SIB-less cell) associated with the SIB-less cells. In addition, a list (including PCI, CGI, frequency information or the like) of anchor cells that support SIB-less cells may be included. When only an indicator indicating collection and storage of the information related to an SIB-less cell is included, the UE 1i-05 collects and stores measurement results associated with all SIB-less cells supported by an anchor cell belonging to a RPLMN or ePLMN. The UE 1i-05 is switched from a connected mode to an idle mode or inactive mode, and performs a logged MDT operation according to the configuration information in operation 1i-25. The UE 1i-05 camps on a single anchor cell 1i-10, and obtains predetermined configuration information related to an adjacent SIB-less cell supported by the anchor cell, which is included in predetermined system information broadcasted by the cell, in operation 1i-30. In this instance, the base station that transmits LoggedMeasurementConfiguration in operation 1i-20 and the anchor cell 1i-10 may be the same entity or may be different entities from each other. For example, the predetermined configuration information is the PCI of an SIB-less cell, CGI, frequency information (ARFCN-ValueNR), and SSB scheduling information of an SIB-less cell. In this instance, the UE 1i-05 may recognize, based on the configuration information, SIB-less cells around the anchor cell, and collects and stores predetermined information related to an SIB-less cell supported by the anchor cell according to the logged MDT configuration information included in LoggedMeasurementConfiguration in operation 1i-35. When a list of SIB-less cells to be stored is included in the previously received LoggedMeasurementConfiguration message, the UE 1i-05 collects and stores predetermined information associated with only the SIB-less cells included in the list among the SIB-less cells supported by the anchor cell. Information that the UE 1i-05 needs to collect and store in associated with an SIB-less cell is as follows. In this instance, among the SIB-less cells to be stored, there are an SIB-less cell detected by the UE 1i-05 and an SIB-less cell that is not detected. In the case of a detected SIB-less cell, the UE 1i-05 stores the following information.
A PCI (PhysCellId) and carrier frequency of a detected SSB-less cell.
Cell measurement results (RSRP and/or RSRQ) of a detected SSB-less cell.
A cell ID (PCI, CGI, or the like) of an anchor cell and a cell index used for the anchor cell to indicate a detected SSB-less cell.

The UE stores the following information in association with an SIB-less cell that is not detected.
A PCI (PhysCellId) and carrier frequency of a SSB-less cell that is not detected.
A cell ID (PCI, CGI, or the like) of an anchor cell and a cell index used for the anchor cell to indicate an SSB-less cell that is not detected.

The stored information may be reported to the base station by the UE 1i-05 via a UE information process.

FIG. 1J is a flowchart of an operation that collects information associated with failure of connection with an SIB-less cell according to an embodiment of the disclosure.

An anchor cell 1j-10 transmits, to a predetermined UE 1j-05, paging including information indicating access to an SIB-less cell supported by the anchor cell 1j-10, so that the UE 1j-05 connects to the predetermined SIB-less cell. The paging message includes an indicator indicating, to the UE 1j-05, attempt to access to the predetermined SIB-less cell, instead of the anchor cell. Alternatively, the anchor cell may transmit, to the UE 1j-05, a separate paging message indicating attempt to access to the predetermined SIB-less cell, instead of the anchor cell. The UE 1j-05 may obtain information associated with an SIB-less supported by the anchor cell and scheduling information associated with a paging occasion for a separate paging message, via system information of the anchor cell in operation 1j-15. The UE 1j-05 that receives, from the anchor cell, a paging message 1j-20 indicating access to a predetermined SIB-less cell performs a random access process with respect to the SIB-less cell. In this instance, the UE 1j-05 in an idle mode performs an RRC establishment operation, and the UE 1j-05 in an inactive mode performs an RRC resume operation. However, when the random access process is not successfully completed during a predetermined time, the UE 1j-05 regards the establishment or resume process as failed. In this instance, the UE 1j-05 stores a predetermined content to be included in a connection establishment failure (CEF) report in operation 1j-30. As information to be stored, the UE 1j-05 includes information associated with an SIB-less cell to which access is attempted. The information is as follows.
An indicator indicating whether a cell to which access is attempted is an SIB-less cell.
Anchor cell information (PCI, CGI, frequency information or the like) that supports an SIB-less cell to which access is attempted.

After failure, the UE 1j-05 attempts to access the anchor cell or a predetermined base station, and transmits, to the base station, an indicator indicating that the UE 1j-05 itself stores a CEF report content in operation 1j-35. The base station that receives the indicator may request the UE 1j-05 to report the CEF report in operation 1j-40. The UE 1j-05 that receives the request transmits the CEF report that the UE 1j-05 stores to the base station in operation 1j-45.

FIG. 1k is a flowchart of a UE operation that collects and reports NES related information according to an embodiment of the disclosure.

In operation 1k-05, the UE receives a LoggedMeasurementConfiguration message from a base station.

In operation 1k-10, the UE receives an RRCRelease message from the base station and switches to an idle mode or inactive mode.

In operation 1k-15, the UE performs a logged MDT operation according to configuration information received via the LoggedMeasureemntConfiguration message.

In operation 1k-20, the UE stores predetermined information proposed in the embodiment. The predetermined information may include information indicating whether cell DTX affects, and information related to an SIB-less cell.

In operation 1k-25, the UE performs an establishment or resume process with respect to a predetermined base station, and includes an indicator indicating that the UE stores predetermined MDT information in an RRCSetupComplete or RRCResumeComplete message and reports the same to the base station.

In operation 1k-30, the UE is requested, by the base station, to report an MDT measurement result.

In operation 1k-35, the UE reports the stored MDT measurement result to the base station.

FIG. 1L is a flowchart of a base station operation that collects and reports NES related information according to an embodiment of the disclosure.

In operation 1l-05, a base station transmits a LoggedMeasurementConfiguration message to a UE.

In operation 1l-10, the base station transmits an RRCRelease message to the UE so as to switch the UE to an idle mode or inactive mode.

In operation 1l-15, via an RRC (re) establishment or RRC resume process, the base station receives, from the UE, an indicator indicating that the UE stores an MDT measurement result during a logged MDT process.

In operation 1l-20, the base station requests the UE to report the MDT measurement result.

In operation 1l-25, the base station receives the requested report of the MDT measurement result from the UE.

FIG. 1M is a block diagram illustrating an internal structure of a UE according to an embodiment of the disclosure.

Referring to FIG. 1M, the UE may include a radio frequency (RF) processor 1m-10, a baseband processor 1m-20, a storage unit 1m-30, and a controller 1m-40.

The RF processor 1m-10 may perform functions for transmitting/receiving signals through a radio channel, such as signal band conversion and amplification. That is, the RF processing unit 1m-10 up-converts a baseband signal provided from the baseband processing unit 1m-20 to an RF band signal, transmits the same through an antenna, and down-converts an RF band signal received through the antenna to a baseband signal. For example, the RF processor 1m-10 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. In addition, the RF processor 1m-10 may include multiple RF chains. Furthermore, the RF processor 1m-10 may perform beamforming. For the beamforming, the RF processor 1m-10 may adjust the phase and magnitude of each of signals transmitted and received through multiple antennas or antenna elements. In addition, the RF processor may perform MIMO, and may receive multiple layers when performing a MIMO operation.

The baseband processor 1m-20 may perform functions of conversion between baseband signals and bitstrings according to the system's physical layer specifications. For example, during data transmission, the baseband processor 1m-20 may encode and modulate a transmitted bitstring to generate complex symbols. In addition, during data reception, the baseband processor 1m-20 may demodulate and decode a baseband signal provided from the RF processor 1m-10 to restore a received bitstring. For example, when following the orthogonal frequency division multiplexing (OFDM) scheme, during data transmission, the baseband processor 1m-20 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 1m-20 may split a baseband signal provided from the RF processor 1m-10 at the OFDM symbol level, may restore signals mapped to subcarriers through a fast Fourier transform (FFT) operation, and may restore a received bitstring through demodulation and decoding.

The baseband processor 1m-20 and the RF processor 1m-10 may transmit and receive signals as described above. Therefore, the baseband processor 1m-20 and the RF processor 1m-10 may be each referred to as a transmitter, a receiver, a transceiver, or a communication unit. Furthermore, at least one of the baseband processor 1m-20 and the RF processor 1m-10 may include multiple communication modules to support multiple different radio access technologies. In addition, at least one of the baseband processor 1m-20 and the RF processor 1m-10 may include different communication modules to process signals in different frequency bands. For example, the different radio access technologies may include wireless LANs (for e.g., IEEE 802.11), cellular networks (e.g., LTE), and the like. In addition, the different frequency bands may include super high frequency (SHF) (e.g., 2 NRHz) bands and millimeter wave (mmWave) (e.g., 60 GHz) bands.

The storage unit 1m-30 may store basic programs, application programs, and data, such as configuration information, for operation of the main base station. Particularly, the storage unit 1m-30 may store information regarding a second access node configured to perform wireless communication by using a second radio access technology. In addition, the storage unit 1m-30 provides the stored data at the request of the controller 1m-40.

The controller 1m-40 controls the overall operation of the UE. For example, the controller 1m-40 may transmit/receive signals through the baseband processor 1m-20 and the RF processor 1m-10. In addition, the controller 1m-40 records data in the storage unit 1m-30 and reads the data from the storage unit 1m-30. To this end, the controller 1m-40 may include at least one processor. For example, the controller 1m-40 may include a communication processor (CP) configured to perform control for communication, and an application processor (AP) configured to control upper layers such as application programs. The controller 1m-40 may further include a multi-connection processor 1m-42 to support multiple connections.

FIG. 1N is a block diagram illustrating a structure of a base station according to an embodiment of the disclosure.

As illustrated in the drawing, the base station may include an RF processor 1n-10, a baseband processor 1n-20, a backhaul communication unit 1n-30, a storage unit 1n-40, and a controller 1n-50.

The RF processor 1n-10 may perform functions for transmitting/receiving signals through a radio channel, such as signal band conversion and amplification. That is, the RF processor 1n-10 up-converts a baseband signal provided from the baseband processor 1n-20 to an RF band signal, transmits the same through an antenna, and down-converts an RF band signal received through the antenna to a baseband signal. For example, the RF processor 1n-10 may include a transmission filter, a reception filter, an amplifier, a mixer, an oscillator, a DAC, and an ADC. Although only one antenna is illustrated in the drawing, the first access node may include multiple antennas. In addition, the RF processor 1n-10 may include multiple RF chains. Furthermore, the RF processor 1n-10 may perform beamforming. For the beamforming, the RF processor 1n-10 may adjust the phase and magnitude of each of signals transmitted and received through multiple antennas or antenna elements. The RF processor may transmit one or more layers to perform a downward MIMO operation.

The baseband processor 1n-20 may perform functions of conversion between baseband signals and bitstrings according to the physical layer specifications of first radio access technology. For example, during data transmission, the baseband processor 1n-20 may encode and modulate a transmitted bitstring to generate complex symbols. In addition, during data reception, the baseband processor 1n-20 may demodulate and decode a baseband signal provided from the RF processor 1n-10 to restore a received bitstring. For example, when following the OFDM scheme, during data transmission, the baseband processor 1n-20 may encode and modulate a transmitted bitstring to generate complex symbols, may map the complex symbols to subcarriers, and may configure OFDM symbols through IFFT operation and CP insertion. In addition, during data reception, the baseband processor 1n-20 may split a baseband signal provided from the RF processor 1n-10 at the OFDM symbol level, may restore signals mapped to subcarriers through FFT operation, and may restore a received bitstring through demodulation and decoding. The baseband processor 1n-20 and the RF processor 1n-10 may transmit and receive signals as described above. Therefore, the baseband processor 1n-20 and the RF processor 1n-10 may be each referred to as a transmitter, a receiver, a transceiver, a communication unit, or a wireless communication unit.

The backhaul communication unit 1n-30 may provide an interface for communicating with other nodes in the network. That is, the backhaul communication unit 1n-30 may convert bitstrings transmitted from the main base station to other nodes (for example, auxiliary base station, core network) to physical signals, and may convert physical signals received from the other nodes to bitstrings.

The storage unit 1n-40 may store basic programs, application programs, and data, such as configuration information, for operation of the main base station. Particularly, the storage unit 1n-40 may store information regarding a bearer allocated to a connected UE, a measurement result reported from the connected UE, and the like. In addition, the storage unit 1n-40 may store information serving as a reference to determine whether to provide multi-connection to a UE or to suspend the same. In addition, the storage unit 1n-40 provides the stored data at the request of the controller 1o-40.

The controller 1n-50 controls the overall operation of the main base station. For example, the controller 1n-50 may transmit/receive signals through the baseband processor 1n-20 and the RF processor 1n-10 or through the backhaul communication unit 1n-30. In addition, the controller 1n-50 records data in the storage unit 1n-40 and reads the data from the storage unit 1n-40. To this end, the controller 1n-50 may include at least one processor. The controller 1n-50 may further include a multi-connection processor 1n-52 to support multiple connections.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. For example, a part or all of an embodiment may be combined with a part or all of one or more other embodiments, and it is natural that an implementation of such combination also corresponds to an embodiment proposed by the disclosure. Therefore, the scope of the disclosure should not be defined as being limited to the embodiments set forth herein, but should be defined by the appended claims and equivalents thereof.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a terminal in a wireless communication system, the method comprising:
transmitting, to a base station, capability information including an indicator indicating that the terminal supports a network saving energy (NES) function;
receiving, from the base station, first configuration information including an indicator indicating collection and storage of NES information for performing logged minimization of drive test (MDT); and
based on the first configuration information, performing the logged MDT in an idle state or inactive state.

2. The method of claim 1, wherein the performing of the logged MDT further comprises:
obtaining cell discontinuous transmit (DTX) pattern information associated with at least one cell;
based on the cell DTX pattern information, obtaining time interval information in which a synchronization signal block (SSB) is not transmitted in association with the at least one cell;
storing information corresponding to the time interval information; and
reporting the information corresponding to the time interval information to the base station.

3. The method of claim 1,
wherein the capability information further comprises an indicator indicating that the terminal supports a system information block (SIB)-less cell,
wherein the first configuration information further comprises an indicator indicating collection and storage of information related to the SIB-less cell, and
wherein the performing of the logged MDT further comprises:
obtaining second configuration information including identifier information associated with the at least one SIB-less cell, and
based on the second configuration information, storing information associated with the at least one SIB-less cell.

4. The method of claim 3,
wherein the second configuration information further comprises frequency information or synchronization signal block (SSB) scheduling information associated with the at least one SIB-less cell, and
wherein the storing of the information associated with the at least one SIB-less cell comprises at least one of an identifier, a carrier frequency, or a cell measurement result associated with the at least one SIB-less cell.

5. A method performed by a base station in a wireless communication system, the method comprising:
receiving, from a terminal, capability information including an indicator indicating that the terminal supports a network saving energy (NES) function;
transmitting, to the terminal, first configuration information including an indicator indicating collection and storage of NES information for performing logged minimization of drive test (MDT); and
receiving, from the terminal, a report associated with the logged MDT.

6. The method of claim 5, further comprising transmitting cell discontinuous transmit (DTX) pattern information representing time interval information in which a synchronization signal block (SSB) is not transmitted in association with at least one cell,
wherein the report comprises information corresponding to the time interval information in which the synchronization signal block (SSB) is not transmitted.

7. The method of claim 5,
wherein the capability information further comprises an indicator indicating that the terminal supports a system information block (SIB)-less cell,
wherein the first configuration information further comprises an indicator indicating collection and storage of information related to the SIB-less cell,
wherein the method further comprises transmitting second configuration information including identifier information associated with the at least one SIB-less cell, and
wherein the report comprises information associated with the at least one SIB-less cell.

8. The method of claim 7,
wherein the second configuration information further comprises frequency information or synchronization signal block (SSB) scheduling information associated with the at least one SIB-less cell, and
wherein the information associated with the at least one SIB-less cell comprises at least one of an identifier, a carrier frequency, or a cell measurement result associated with the at least one SIB-less cell.

9. A terminal in a wireless communication system, the terminal comprising:
a transceiver; and
a controller connected to the transceiver,
wherein the controller is configured to:
transmit, to a base station, capability information including an indicator indicating that the terminal supports a network saving energy (NES) function,
receive, from the base station, first configuration information including an indicator indicating collection and storage of NES information for performing logged minimization of drive test (logged MDT), and
based on the first configuration information, perform the logged MDT in an idle state or inactive state.

10. The terminal of claim 9, wherein the controller is configured to:
obtain cell discontinuous transmit (DTX) pattern information associated with at least one cell;
based on the cell DTX pattern information, obtain time interval information in which a synchronization signal block (SSB) is not transmitted in association with the at least one cell;
store information corresponding to the time interval information; and
report the information corresponding to the time interval information to the base station.

11. The terminal of claim 9,
wherein the capability information further comprises an indicator indicating that the terminal supports a system information block (SIB)-less cell,
wherein the first configuration information further comprises an indicator indicating collection and storage of information related to the SIB-less cell, and
wherein the controller is configured to:
obtain second configuration information including identifier information associated with the at least one SIB-less cell, and
based on the second configuration information, store the information associated with the at least one SIB-less cell.

12. The terminal of claim 11,
wherein the second configuration information further comprises frequency information or synchronization signal block (SSB) scheduling information associated with the at least one SIB-less cell, and
wherein the controller is configured to store at least one of an identifier, a carrier frequency, or a cell measurement result associated with the at least one SIB-less cell.

13. A base station in a wireless communication system, the base station comprising:
a transceiver; and
a controller connected to the transceiver,
wherein the controller is configured to:
receive, from a terminal, capability information including an indicator indicating that the terminal supports a network saving energy (NES) function,
transmit, to the terminal, first configuration information including an indicator indicating collection and storage of NES information for performing logged minimization of drive test (MDT), and
receive a report associated with the logged MDT from the terminal.

14. The base station of claim 13,
wherein the controller is configured to transmit cell discontinuous transmit (DTX) pattern information representing time interval information in which a synchronization signal block (SSB) is not transmitted in association with at least one cell, and
wherein the report comprises information corresponding to time interval information in which the synchronization signal block (SSB) is not transmitted.

15. The base station of claim 13,
wherein the capability information further comprises an indicator indicating that the terminal supports a system information block (SIB)-less cell,
wherein the first configuration information further comprises an indicator indicating collection and storage of information related to the SIB-less cell,
wherein the controller is further configured to transmit second configuration information including identification information associated with the at least one SIB-less cell,
wherein the report comprises information associated with the at least one SIB-less cell, and
wherein the information associated with the at least one SIB-less cell comprises at least one of an identifier, a carrier frequency, or a cell measurement result associated with the at least one SIB-less cell.
